(19) United States
(12) Patent Application Publication
(10) Pub. No.: US 2018/0187049 A1
(43) Pub. Date: Jul. 5, 2018

(54) REACTIVE HOT MELT ADHESIVE

(71) Applicant: BASF SE, Ludwigshafen (DE)

(72) Inventors: Rifat Tabakovic, Rochester Hills, MI (US); Dahlia Campbell, Southgate, MI (US); Heinz Peter Plaumann, Brownstown, MI (US); Afsaneh Nabifar, Ann Arbor, MI (US); Jan Rudloff, Ann Arbor, MI (US); Jon A. Debling, Saline, MI (US)

(73) Assignee: BASF SE, Ludwigshafen (DE)

(21) Appl. No.: 15/740,992

(22) PCT Filed: Jun. 29, 2016
(86) PCT No.: PCT/US2016/040057

§ 371 Date: Dec. 29, 2017

Related U.S. Application Data
(60) Provisional application No. 62/185,961, filed on Jun. 29, 2015.

(51) Int. Cl. C09J 5/06; C09J 11/08; C09J 175/04; C09J 175/08; C09J 175/06; C08G 18/10; C08G 18/76; C08G 18/48; C08G 18/42; C08G 18/40; C08G 18/20; C09J 125/14; C09J 133/12; C09J 133/08; B32B 7/12

(52) U.S. Cl. CPC C09J 5/06; B32B 2255/26; C09J 175/04; C09J 175/08; C09J 175/06; C08G 18/10; C08G 18/7671; C08G 18/4829; C08G 18/4244; C08G 18/4018; C08G 18/4816; C08G 18/2081; C09J 125/14; C09J 133/12; C09J 133/08; B32B 7/12; C09J 2475/00; C09J 2425/00; C09J 2433/00; B32B 2250/02; C09J 11/08

(57) ABSTRACT

A reactive hot melt adhesive has a glass transition temperature of from 45° C. to 100° C. The reactive hot melt adhesive includes the reaction product of: an isocyanate component and an isocyanate reactive component chosen from a polyester, a polyether, and combinations thereof. The isocyanate component and the isocyanate reactive component react in the presence of a styrene acrylic resin that is free of hydroxyl functionality and that is the reaction product of 60 to 80 wt % of one or more monomers chosen from C₁ to C₂₀ alkyl acrylates and methacrylates and 20 to 40 wt % of one or more monomers chosen from vinylaromatics having a vinyl moiety having 2 or 3 carbon atoms.

### FIELD OF THE DISCLOSURE

The present disclosure generally relates to a reactive hot melt adhesive. More specifically, the present disclosure relates to a reactive hot melt adhesive including the reaction product of an isocyanate component and an isocyanate reactive component, in the presence of a styrene acrylic resin that is free of hydroxyl functionality.

### BACKGROUND

Hot melt adhesives, also known as hot melts, are generally polymeric adhesives having the characteristic of easily melting due to the heat in order to be processed and to solidify after cooling. Hot melt adhesives are typically in the form of blocks, bars, granules, powders and films at room temperature. Upon heating, the hot melt adhesives melt to form a molten state and become tacky. After cooling, the hot melt adhesives reform into solids and form physical bonds between substrates. Typically, hot melt adhesives exhibit rapid increases of internal forces during the cooling thereby allowing for rapid setting. The market for hot melt adhesives is very wide and fulfills the requirements of various industrial sectors such as wood and wood products, paper, paper industry, electronics, shipbuilding and many more.

Some hot melt adhesives are based on ethylene-vinyl acetate (EVA), polyolefins, polyamides, polyurethanes, polycaprolactones, fluoro polymers, and other similar compounds. However, these hot melt adhesives can be expensive and difficult to form. Accordingly, there remains an opportunity for improvement.

### SUMMARY OF THE DISCLOSURE

This disclosure provides a reactive hot melt adhesive and has a glass transition temperature of from 45° C. to 100° C. The reactive hot melt adhesive includes the reaction product of: an isocyanate component and an isocyanate reactive component chosen from a polyester, a polyether, and combinations thereof. The isocyanate component and the isocyanate reactive component react in the presence of a styrene acrylic resin that is free of hydroxyl functionality and that is the reaction product of 60 to 80 wt % of one or more monomers chosen from C₁ to C₂₀ alkyl acrylates and methacrylates and 20 to 40 wt % of one or more monomers chosen from vinylaromatics having a vinyl moiety having 2 or 3 carbon atoms.

### BRIEF DESCRIPTION OF THE FIGURES

Other advantages of the present disclosure will be readily appreciated, as the same becomes better understood by reference to the following detailed description when considered in connection with the accompanying drawings wherein:

FIG. 1 is a line graph of adhesion as a function of open time for various Adhesives of the Examples;

FIG. 2 is a line graph of adhesion as a function of closed time for various Adhesives of the Examples;

FIG. 3 is a line graph of adhesion as a function of closed time for various Adhesives of the Examples;

FIG. 4 is a line graph of adhesion as a function of closed time for various Adhesives of the Examples;

FIG. 5 is a line graph of adhesion as a function of closed time for various Adhesives of the Examples;

FIG. 6 is a line graph of adhesion as a function of open time for various Adhesives of the Examples;

FIG. 7 is a line graph of adhesion as a function of closed time for various Adhesives of the Examples;

FIG. 8 is a line graph of adhesion as a function of closed time for various Adhesives of the Examples; and

FIG. 9 is a line graph of adhesion as a function of closed time for various Adhesives of the Examples.

### DETAILED DESCRIPTION OF THE DISCLOSURE

This disclosure provides a reactive hot melt adhesive (hereinafter described as the adhesive). The terminology “reactive” describes that that a reaction takes place in this hot melt adhesive such that a cross-linked final adhesive is formed. Typically, there are two reactions that can occur. A first reaction is typically between an isocyanate component and an isocyanate reactive component. This reaction forms a polyurethane. If this polyurethane has unused/available isocyanate groups, then these isocyanate groups can self-polymerize and cross-link in a second reaction thereby forming a cross-linked final adhesive. Each of these reactions is described in greater detail below.

The adhesive is typically solid at room temperature, e.g. at a temperature of 23 to 28, 24 to 27, 25, or 26° C. The terminology “solid” describes that the adhesive does not flow at room temperature, as is understood by those of skill in the art. For example, the adhesive at room temperature may be described as having an infinite viscosity. In various embodiments, the adhesive melts, flows, or becomes a liquid at temperatures of from 230 to 290, from 235 to 275, or from 240-250, ° F.

In various embodiments, the adhesive has an isocyanate (NCO) group content of from 1.2 to 2.2, from 1.8 to 1.9, or from 1.6 to 1.7, wt %, as determined using a modified version of D5155-14, titration with dibutylamine, and using a Metier Toledo T-50 NCO titrator. In other embodiments, the reactive hot melt adhesive has a viscosity (which may be an initial viscosity) of from 4,000 to 40,000, from 4,400 to 7,200, or from 14,000 to 28,000, centipoises (cP) measured at 250° C. using ASTM D1084-08, a Brookfield Thermosel DV2T, and a #27 spindle. The viscosity of the adhesive and the NCO content may be related. For example, as NCO content goes down, viscosity may increase. Similarly, cure may be increased when moisture is present and when NCO content is low. For example, if NCO content is too low, then the adhesive may prematurely react and form a gel in a reactor. In still other embodiments, the adhesive exhibits an initial adhesion of greater than 30, 35, 40, 45, 50, 55, or 60, lbF as determined according to ASTM D905, D3807, D1062, or modified versions thereof and an open time of about 1, 1.25, 1.5, 1.75, 2, 2.25, 2.5, 2.75, or 3, minutes. In other embodiments, the adhesive exhibits an initial adhesion of greater than 30, 35, 40, 45, or 50, lbF as determined according to ASTM D905, D3807, D1062, or modified versions thereof and an open time of about 7, 7.25, 7.5, 7.75, 8, 8.25, 8.5, 8.75, or 9, minutes. Open time is typically defined as a time interval between a point when adhesive is applied on a first substrate and a point when a second substrate is placed on the top of the first substrate with the adhesive disposed therebetween. For example, adhesive (in an amount of 10-15 grams/ft²) can be applied using a lab roll coater. A stop watch can be used to measure open time. Samples are typically pressed for 10 seconds with 90 psi of pressure using a pneumatic press.

### Isocyanate Component:

As first described above, the adhesive includes the reaction product of an isocyanate component and an isocyanate reactive component. The isocyanate component is not particularly limited and may be any known in the art. In various embodiments, the isocyanate component comprises a plurality of isocyanate (NCO) functional groups, e.g. 2, 3, 4, 5, 6, 7, or 8 functional groups, or any value or ranges of values therein.

Suitable organic polyisocyanates include, but are not limited to, conventional aliphatic, cycloaliphatic, araliphatic and aromatic isocyanates. In certain embodiments, the isocyanate is chosen from the group of diphenylmethane diisocyanates (MDIs), polymeric diphenylmethane diisocyanates (pMDIs), and combinations thereof. Polymeric diphenylmethane diisocyanates can also be called polymethylene polyphenylene polyisocyanates. In other embodiments, the isocyanate is an emulsifiable MDI (eMDI). Examples of other suitable isocyanates include, but are not limited to, toluene diisocyanates (TDIs), hexamethylene diisocyanates (HDIs), isophorone diisocyanates (IPDIs), naphthalene diisocyanates (NDIs), and combinations thereof. In a specific embodiment, the isocyanate is MDI. In another specific embodiment, the isocyanate is pMDI, i.e., polymeric methylene-4,4′-diphenyl diisocyanate. In further specific embodiments, the isocyanate is a combination of MDI and pMDI. Typical examples of 4,4′-diphenylmethane diisocyanates are commercially available from BASF Corporation of Wyandotte, Mich., under the trade names of Lupranate® MM103, Lupranate® M, Lupranate® MP102, Lupranate® LP30, and Lupranate® LP30D. In one embodiment, the isocyanate is Lupranate® M (MDI) or pMDI.

It is contemplated that the isocyanate component may include more than one individual isocyanate. Any additional isocyanates may be aliphatic or aromatic. If the isocyanate component includes an aromatic isocyanate, the aromatic isocyanate typically corresponds to the formula R′(NCO)_{z} wherein R′ is a polyvalent organic radical which is aromatic and z is an integer that corresponds to the valence of R′. Typically, z is at least two. Aromatic isocyanates that may be used include, but are not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisochyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, polymethylene polyphenylene polyisocyanate, corresponding isomeric mixtures thereof, and combinations thereof.

The isocyanate component may also include a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The isocyanate component may also include, but is not limited to, modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. The isocyanate component may further include stoichiometric or non-stoichiometric reaction products of the aforementioned isocyanates. The isocyanate component may alternatively include an aliphatic isocyanate, and/or combinations of the aromatic isocyanate and the aliphatic isocyanate.

In certain embodiments, the isocyanate component is or includes an isocyanate-terminated prepolymer or a polyurethane prepolymer having unreacted isocyanate moieties. The prepolymer is typically a reaction product of an isocyanate and a polyol and/or a polyamine. The isocyanate component may be any type of isocyanate in the polyurethane art, such as one of the polyisocyanates. If utilized to make the isocyanate-terminated prepolymer, the polyol is typically chosen from the group of ethylene glycol, diethylene glycol, propylene glycol, dipropylene glycol, butane diol, glycerol, trimethylolpropane, triethanolamine, pentaerythritol, sorbitol, and combinations thereof. The polyol may also be a polyol as described and exemplified further below with discussion of the isocyanate-reactive component. If utilized to make the prepolymer, the polyamine is typically chosen from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof. The prepolymer may be formed from a combination of two or more of the aforementioned polyols and/or polyamines. The prepolymer may be moisture cured or curable, e.g. at room temperature.

It is contemplated that the isocyanate component may have any % NCO content, any nominal functionality, any number average molecular weight, and any viscosity, depending on which isocyanate component is chosen. Examples of particularly useful isocyanate components of the present invention typically have % NCO contents of from 8 to 40, more typically of from 10 to 30, and most typically of from 20 to 35, percent by weight. Determination of the % NCO contents on percents by weight is accomplished by a standard chemical titration analysis known to those skilled in the art. It is to be understood that the isocyanate component may have any molecular weight.

### Isocyanate-Reactive Component:

Referring now to the isocyanate-reactive component, this component may be, include, consist essentially of, or consist of a polyol and/or a polyamine, e.g. those having a plurality of functional groups (e.g. OH or NH functional groups) that are reactive with the NCO functional groups of the isocyanate component.

In an example, the isocyanate-reactive component is a polyol and/or a polyamine. The polyol and/or the polyamine can have any functionality, e.g. of at least 2, 2, 3, 4, 5, 6, 7, or 8, or any value or range of values therebetween.

The polyol is not particularly limited and may be any described above chosen from polyester polyol, a polyether polyol, a polyether/ester polyol, and combinations thereof. In other embodiments, the polyol is a caprolactone based polyol, a poly THF polyol, a polycarbonate polyol, a bio based polyol, and combinations thereof, as would be understood in the art. Furthermore, the isocyanate-reactive component may be chosen from aliphatic polyols, cycloaliphatic polyols, aromatic polyols, heterocyclic polyols, and combinations thereof. Some examples of suitable isocyanate-reactive components include, but are not limited to, glycol-initiated polyols, glycerine-initiated polyols, sucrose-initiated polyols, sucrose/glycerine-initiated polyols, trimethylolpropane-initiated polyols, and combinations thereof.

Suitable polyether polyols include products obtained by the polymerization of a cyclic oxide, such as ethylene oxide (EO), propylene oxide (PO), butylene oxide (BO), and tetrahydrofuran in the presence of a polyfunctional initiator. Suitable initiator compounds include a plurality of active hydrogen atoms, and include, but are not limited to, water, butanediol, ethylene glycol, propylene glycol, diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof.

Other suitable polyether polyols include polyether diols and triols, such as polyoxypropylene diols and triols and poly(oxyethylene-oxypropylene)diols and triols obtained by simultaneous or sequential addition of ethylene and propylene oxides to di- or trifunctional initiators. Copolymers having oxyethylene contents of from about 5 to about 95% by weight, and copolymers having oxypropylene contents of from about 5 to about 100% by weight, based on the total weight of the polyol component, may also be used. These copolymers may be block copolymers, random/block copolymers, or random copolymers. Yet other suitable polyether polyols include polytetramethylene glycols obtained by the polymerization of tetrahydrofuran.

In an example, the isocyanate-reactive component is a polyether polyol that is capped. The term “capped”, as used herein, means that one or more terminals of the polyether polyol is occupied by an alkylene oxide group, for example. In an example, the polyether polyol is capped with ethylene oxide. In other examples, the polyether polyol is capped with ethylene oxide, propylene oxide, butylene oxide, and combinations thereof.

In one example, the isocyanate-reactive component is a polyether polyol having an M_{w} of from about 3,000 to about 6,000. In yet another example, the isocyanate-reactive component is a polyether polyol having an M_{w} of from about 4,000 to about 6,000. In still another example, the isocyanate-reactive component is a polyether polyol having an M_{w} of from about 4,800 to about 5,000.

Suitable polyester polyols include hydroxyl-terminated reaction products of polyhydric alcohols, polyester polyols obtained by the polymerization of lactones, e.g. caprolactone, in conjunction with a polyol, and polyester polyols obtained by the polymerization of hydroxy carboxylic acids, e.g. hydroxy caproic acid. Polyesteramide polyols, polythioether polyols, polyester polyols, polycarbonate polyols, polyacetal polyols, and polyolefin polyols may also be used.

In certain examples, the isocyanate-reactive component of the system includes a natural oil polyol (NOP), which is also known as a biopolyol. In other words, the polyol is not a petroleum-based polyol, i.e., a polyol derived from petroleum products and/or petroleum by-products. In general, there are a few naturally occurring vegetable oils that include unreacted OH functional groups, and castor oil is typically commercially available and is produced directly from a plant source that has sufficient OH functional group content to make castor oil suitable for direct use as a polyol in urethane chemistry. Most, if not all, other NOPs require chemical modification of the oils directly available from plants. The NOP is typically derived from any natural oil, such as from a vegetable or nut oil. Examples of suitable natural oils include castor oil, and NOPs derived from soybean oil, rapeseed oil, coconut oil, peanut oil, canola oil, etc. Employing such natural oils can be useful for reducing environmental footprints.

In some examples, the isocyanate-reactive component includes a graft polyol. In one example, the graft polyol is a polymer polyol. In other examples, the graft polyol is chosen from the group of polyharnstoff (PHD) polyols, polyisocyanate polyaddition (PIPA) polyols, and combinations thereof. Graft polyols may also be referred to as graft dispersion polyols or graft polymer polyols. In one example, the isocyanate-reactive component includes a styrene-acrylonitrile graft polyol.

In still another example, the isocyanate-reactive component may be a polyamine including one or more amine (NH) functional groups. In this case, the isocyanate-reactive component typically includes at least two amine groups. The polyamine may be chosen from any type of polyamine. Some examples of suitable polyamines include ethylene diamine, toluene diamine, diaminodiphenylmethane, polymethylene polyphenylene polyamines, aminoalcohols, and combinations thereof. Examples of aminoalcohols include ethanolamine, diethanolamine, triethanolamine, and combinations thereof. It is to be appreciated that the isocyanate-reactive component may include any combination of the aforementioned polyols and/or polyamines.

In one embodiment, the reaction product of the isocyanate component and the isocyanate reactive component is further defined as a polyurethane prepolymer having unreacted isocyanate moieties. Said differently, in this embodiment, the reaction product has isocyanate groups that are left unreacted and that can be further reacted. For example, these isocyanate groups may react such that the polyurethane prepolymer is further defined as or includes a self-polymerization product, i.e., the reaction product of molecules of the polyurethane prepolymer reacting with themselves, e.g. via the isocyanate moieties. Alternatively, the reactive hot melt adhesive may include a self-polymerization product of the isocyanate component. Moreover, the reactive hot melt adhesive may include a moisture cured product of the isocyanate component.

### Styrene Acrylic Resin:

The adhesive also includes a styrene acrylic resin. The terminology “styrene acrylic resin” is as understood in the art. For example, this terminology may describe an oligomer composition including an oligomer (e.g. an oligomer having a weight average molecular weight as measured by GPC of no more than 100,000 g/mol), and a solid material (e.g. in an amount greater than or equal to 95% by weight of oligomer composition), under standard conditions. Alternatively, this terminology may describe a resin having a range of molecular weights and distributions for more versatility in polymer design allowing for lower VOCs; narrow polydispersity resulting in tightly-controlled physical properties; product consistency; and flexibility in raw material processing for a wide product offering.

Alternatively, the terminology may describe a composition formed from a continuous process using high temperatures and pressures that form products with a high degree of reproducibility and narrow molecular weight distribution. This can result in products that are more consistent, easier to utilize, and have a higher performance capability than those produced by standard batch polymerization. As just one example, such a process allows for production of resins at nearly 100% solids and free from reaction solvent variations typically found with conventionally produced products polyols. These products can subsequently be cut in non-exempt or exempt solvents, without concern for changes in performance properties.

In various embodiments, the styrene acrylic resin is substantially free of solvent and residual monomer and may be prepared by various methods known in the art including, but not limited to semi-batch polymerization, continuous polymerization in a tubular reactor, CSTR or a cascade of CSTRs.

The styrene acrylic resin is not particularly limited to any physical properties. In various embodiments, the styrene acrylic resin has a weight average molecule weight (M_{w}) of from 20,000 to 60,000, from 25,000 to 45,000, from 30,000 to 40,000, from 33,000 to 60,000, or from 33,000 to 36,000, g/mol. The weight average molecular weight of the styrene acrylic resin may contribute to viscosity, green strength, cure time, and final adhesive properties. In other embodiments, the styrene acrylic resin has an acid number of from 0 to 109, from 5 to 10, from 7.5 to 9.5, from 8 to 9, or from 8.5 to 8.9, mg KOH/g. In further embodiments, the styrene acrylic resin has a glass transition temperature (T_{g}) of from 30 to 100, from 45 to 100, from 30 to 90, from 35 to 85, from 40 to 80, or from 45 to 75, ° C. The glass transition temperature of the styrene acrylic resin may contribute to viscosity, green strength, and final adhesive properties. In even further embodiments, the styrene acrylic resin has a polydispersity index (PDI) of from 1 to 5, from 1.5 to 4.5, from 2 to 4, from 2.5 to 3.5, from 3 to 2.5, from 2.5 to 4, or from 3.5 to 4.0. The PDI of the styrene acrylic resin may contribute to viscosity, green strength, open time, and final cured properties.

The styrene acrylic resin of this disclosure is free of hydroxyl functionality. In one embodiment, the styrene acrylic resin is a copolymer formed from the reaction of styrene, methyl methacrylate and n-butyl methacrylate. In a further embodiment, the styrene acrylic resin is a copolymer formed from the reaction of styrene, and one or more of methyl methacrylate, n-butyl methacrylate, acrylic acid, and/or methacrylic acid. In another embodiment, the styrene acrylic resin is the reaction product of 60 to 80 wt % of one or more monomers chosen from C₁ to C₂₀ alkyl acrylates and methacrylates and 20 to 40 wt % of one or more monomers chosen from vinylaromatics having a vinyl moiety having 2 or 3 carbon atoms. Said differently, the vinylaromatics typically include an aromatic moiety and a vinyl moiety bonded thereto, wherein the vinyl moiety has 2 or 3 carbon atoms, e.g. —CH₂CH═CH₂ or —CH═CH₂. For example, the 60 to 80 wt % may be further described as 65 to 75, 65 to 70, 70 to 80, or 75 to 80, wt %. Moreover, the alkyl acrylates may be any alkyl acrylate or alkyl methacrylate having 1, 2, 3, 4, 5, 6, 7, 8, 9, 10, 11, 12, 13, 14, 15, 16, 17, 18, 19, or 20 carbon atoms in the alkyl group alone or alternatively in both the alkyl and acrylate or methacrylate group. In one embodiment, the alkyl acrylate is a methacrylate having a C₁-C₂₀ alkyl chain on one end and a methacrylate group on the other end. Alternatively, the alkyl acrylate may have a C₁-C₂₀ alkyl chain on one end and an independent C₁-C₂₀ alkyl chain on the other end, wherein the alkyl chains may be the same or different. In addition, the aromatic moiety may be any aromatic moiety and is not limited to strictly a styrene aromatic moiety. Typically, the aromatic moiety is a benzyl ring, e.g. of a styrene molecule. The vinyl moiety may be any in the art having 2, 3, or 4 carbon atoms. Moreover, the 20 to 40 wt % may be alternatively described as 25 to 35, 25 to 30, 30 to 35, or 30 to 40, or 35 to 40, wt %. All ranges of the aforementioned values are also hereby expressly contemplated in various non-limiting embodiments. Moreover, all combinations of two or more of the aforementioned compounds are also hereby expressly contemplated in various non-limiting embodiments.

The styrene acrylic resin may be the reaction product of a first acrylic monomer, a methyl methacrylate monomer, an n-butyl methacrylate monomer, and a styrene monomer. In other words, the styrene acrylic resin may be a compound that results from the reaction of the first acrylic monomer, the methyl methacrylate monomer, the n-butyl methacrylate monomer, and the styrene monomer. In one embodiment, the first acrylic resin is or includes acrylic acid.

The styrene acrylic resin may be further defined as the reaction product of a combination of: from 0.5 to 1.5 parts by weight of the first acrylic monomer, from 10 to 55 parts by weight of the methyl methacrylate monomer, from 15 to 55 parts by weight of the n-butyl methacrylate monomer, and from 15 to 55 parts by weight of the styrene monomer, wherein each is independently chosen and based on 100 parts by weight of the combination.

In various embodiments, the first acrylic monomer is reacted in an amount of from 0.5 to 1, 0.5 to 0.75, 0.75 to 1, 1 to 1.25, 1 to 1.5, or 1.25 to 1.5, parts by weight based on 100 parts by weight of the combination. In other embodiments, the methyl methacrylate monomer is reacted in an amount of from 15 to 50, from 20 to 45, from 25 to 40, or from 30 to 35, parts by weight based on 100 parts by weight of the combination. In still other embodiments, the n-butyl methacrylate monomer is reacted in an amount of from 20 to 50, from 25 to 45, from 30 to 40, or from 30 to 35, parts by weight based on 100 parts by weight of the combination. In further embodiments, the styrene monomer is reacted in an amount of from 15 to 50, 15 to 45, 20 to 50, 20 to 45, 20 to 40, 25 to 35, or 30 to 35, parts by weight based on 100 parts by weight of the combination. In various additional non-limiting embodiments, all values and ranges of values between the aforementioned values are hereby expressly contemplated. Without intending to be bound by any particular theory, in various embodiments, the adhesive first physically hardens, which provides green strength. Subsequently, there is a chemical cure that occurs between isocyanate reactive groups. The styrene monomer may raise the glass transition temperature of the acrylic resin/components such that the adhesive can start to solidify at a higher temperature, as compared to adhesives that do not include the styrene monomer. This may allow for more efficacious use of the adhesive in production facilities wherein temperatures can rise dramatically. For example, relative to hot-melt adhesives, it is beneficial if the adhesive can solidify at a higher temperature such that the adhesive can be used in high environmental temperature production facilities (e.g. during the summer months).

In various embodiments, the styrene acrylic resin is present in an amount of from 1 to 20, from 5 to 15, from 10 to 15, from 5 to 10, or from 6 to 9, parts by weight based on 100 parts by weight of the isocyanate component, the isocyanate reactive component, and the styrene acrylic resin. In various embodiments, such adhesives are used with residential and commercial door applications, e.g. entry doors, garage doors, etc. In other embodiments, the styrene acrylic resin is present in an amount from 20 to 40, from 25 to 35, from 30 to 35, from 5 to 30, or from 24 to 26, parts by weight based on 100 parts by weight of the isocyanate component, the isocyanate reactive component, and the styrene acrylic resin. In various embodiments, such adhesives are used with automotive and recreational vehicle applications.

### Method of Forming the Adhesive:

This disclosure also provides a method of forming the adhesive. The method includes the steps of providing the isocyanate component, providing the isocyanate reactive component chosen from a polyester, a polyether, and combinations thereof, and providing the styrene acrylic resin. The method also includes the step of combining the isocyanate component, the isocyanate reactive component, and the styrene acrylic resin such that the isocyanate component and the isocyanate reactive component react in the presence of the solid grade oligomer to form the reactive hot melt adhesive.

In one embodiment, the step of providing the styrene acrylic resin is further defined as continuously charging a mixture of the one or more monomers chosen from C₁ to C₂₀ alkyl acrylates and methacrylates and the one or more monomers chosen from vinylaromatics including the aromatic moiety and the vinyl moiety bonded thereto, into a reactor (such as a continuous stirred tank reactor (CSTR)) and maintaining the reactor at a temperature of from 120° C. to 190° C., from 120° C. to 165° C., or from 150° C. to 190° C., to polymerize the monomers to form the styrene acrylic resin, and continuously removing the unreacted monomers and the solvent from the reactor to provide the styrene acrylic resin. In another embodiment, the step of providing the styrene acrylic resin is further defined as continuously charging a mixture of the first acrylic monomer, the methyl methacrylate monomer, the n-butyl methacrylate monomer, the styrene monomer, a solvent, and a polymerization initiator into a reactor (such as a continuous stirred tank reactor (CSTR)) and maintaining the reactor at a temperature of from 120° C. to 190° C., from 120° C. to 165° C., or from 150° C. to 190° C., to polymerize the first acrylic monomer, the methyl methacrylate monomer, the n-butyl methacrylate monomer, and the styrene monomer to form the styrene acrylic resin, and continuously removing the unreacted monomers and the solvent from the reactor to provide the styrene acrylic resin. For example, an apparatus may include a devolitization unit after the reactor to continuously remove unreacted monomers and solvents to provide the styrene acrylic resin. In other embodiments, the step of combining further includes combining a flow modifier with the isocyanate component, the isocyanate reactive component, and/or the styrene acrylic resin. The flow modifier may be any known in the art. In still further embodiments, the method includes the step of incorporating an additive into the reactive hot melt adhesive, wherein the additive is chosen from a moisture scavenger, a pigment, an optical absorber, and combinations thereof.

### Article:

This disclosure also provides an article. The article includes a first surface, a second surface spaced from the first surface, and the adhesive disposed between the first and second surfaces for coupling the first and second surfaces to one another. The article may include only three layers, e.g. the first surface, the adhesive, and the second surface. Each of the first and second surfaces may be outermost layers such that there is no additional layer disposed thereon and each faces the environment. Alternatively, one but not the other of the first and second surfaces may be an outermost layer or surface while the other is an inner layer or surface. The first surface may be disposed directly on the adhesive which may be disposed directly on the second surface. Alternatively, the first surface may be disposed on the adhesive and the second surface but spaced apart from the adhesive and/or the second surface. For example, the article may include additional surfaces disposed between the first and second surfaces such as one or more inner surfaces or layers. In various embodiments, the first and second surfaces are each independently chosen from wood surfaces, plastic surfaces, metal surfaces, and combinations thereof. The article may be further defined as a door (e.g. an interior door, an exterior door, or a garage door), a skin, or a sidewall, e.g. for an RV. In other embodiments, the article is further defined as furniture. For example, the furniture may include one or more panels that are adhered together using the adhesive. The article may also include one or more elements that are laminated together using the adhesive. In further embodiments, the article is further defined as a load floor for an automobile, e.g. for use in a trunk. As just one example, carpet may be adhered to the load floor using the adhesive. In other embodiment, the article is further defined as a cabinet door. In even further embodiments, the article is defined as an automobile article. For example, the article may be a headlight assembly that includes one or more elements adhered together using the adhesive.

The article may be formed from a method that includes providing the first and second surfaces, providing the adhesive, and disposing the adhesive between the first and second surfaces for coupling the first and second surfaces to one another. The method may also include one or more steps of pressing and/or heating, as would be determined by one of skill in the art.

### EXAMPLES

Six reactive hot melt adhesives (Adhesives 1-6) and two comparative reactive hot melt adhesives (Comparative Adhesives 1 and 2) are formed. The Adhesives 1-3 are formed using 8 wt % of three different styrene acrylic resins of this disclosure. The Adhesives 4-6 are formed using 24.8 wt % of the same three styrene acrylic resins, respectively. The Comparative Adhesives 1 and 2 are formed using 8 and 24.8 wt %'s of a Comparative Compound and do not include any styrene acrylic resin.

The three styrene acrylic resins of this disclosure (Styrene Acrylic Resins 1-3) and the Comparative Compound are described immediately below.

| | | Styrene | Styrene | Styrene |
|---|---|---|---|---|
| | Comparative | Acrylic | Acrylic | Acrylic |
| | Compound | Resin 1 | Resin 2 | Resin 3 |
| Composition | | | | |
| Acrylic Acid | 1 | 1.35 | 1.28 | 0.77 |
| Methyl | 39.4 | 51.13 | 14.69 | 38.01 |
| Methacrylate | | | | |
| n-Butyl | 59.6 | 28.42 | 51.03 | 20.57 |
| Methacrylate | | | | |
| Styrene | 0 | 19.1 | 33.01 | 40.65 |
| Properties | | | | |
| Weight Average | 59,902 | 34,799 | 35,890 | 33,444 |
| Molecular | | | | |
| Weight | | | | |
| Polydispersity | 2.32 | 3.82 | 3.58 | 3.98 |
| Index | | | | |
| Acid Number | 6 | 8.8 | 8.9 | 8.5 |
| Tg (° C.) | 64.5 | 70 | 47.4 | 74 |

The Comparative Compound is a high molecular weight copolymer of acrylic acid, methyl methacrylate, and n-butyl methacrylate. No styrene is used to form the Comparative Compound.

Weight average molecular weight is determined using gel permeation chromatography. The polymer is first dissolved in a solution of tetrahydrofuran (THF) solvent then injected into a Gel Permeation Chromatogram (Waters 2695 instrument coupled with Waters 2410 Refractive Index Detector). One pair of PLGEL MIXED B columns with one guard column was used and Millennium software was use to determined the number average molecular weight (Mn), weight average molecular weight (Mw) and z average molecular weight (Mz) as calibrated with polystyrene standards.

Polydispersity Index is determined from Gel Permeation Chromatography by taking the mathematical ration of the determined Mw/Mn as described above.

Acid Number is determined by titration of a solution of polymer in THF with sodium or potassium hydroxide solution.

Tg is determined using by differential scanning calorimetry from the midpoint of the second heat.

The Adhesives 1-6 and the Comparative Adhesives 1 and 2 are formed as set forth below wherein all values are grams unless otherwise indicated.

| | Adh. | Adh. | Adh. | Adh. | Adh. | Adh. | Comp. | Comp. |
|---|---|---|---|---|---|---|---|---|
| Parameter | 1 | 2 | 3 | 4 | 5 | 6 | Adh. 1 | Adh. 2 |
| Isocyanate | 22.4 | 22.44 | 22.4 | 11.15 | 11.15 | 11.15 | 22.4 | 11.15 |
| Component | | | | | | | | |
| Isocyanate Reactive | 46.07 | 46.07 | 46.07 | — | — | — | 46.07 | — |
| Component 1 | | | | | | | | |
| Isocyanate Reactive | 22.5 | 22.5 | 22.5 | — | — | — | 22.5 | — |
| Component 2 | | | | | | | | |
| Isocyanate Reactive | — | — | — | 22.1 | 22.1 | 22.1 | — | 22.1 |
| Component 3 | | | | | | | | |
| Isocyanate Reactive | — | — | — | 20.9 | 20.9 | 20.9 | — | 20.9 |
| Component 4 | | | | | | | | |
| Isocyanate | — | — | — | 21.1 | 20.1 | 20.1 | — | 21.1 |
| component 5 | | | | | | | | |
| Catalyst | 0.2 | 0.2 | 0.2 | 0.2 | 0.2 | 0.2 | 0.2 | 0.2 |
| Styrene Acrylic | 8 | — | — | 24.8 | — | — | — | — |
| Resin 1 | | | | | | | | |
| Styrene Acrylic | — | 8 | — | — | 24.8 | — | — | — |
| Resin 2 | | | | | | | | |
| Styrene Acrylic | — | — | 8 | — | — | 24.8 | — | — |
| Resin 3 | | | | | | | | |
| Comparative | — | — | — | — | — | — | 8 | 24.8 |
| Compound | | | | | | | | |
| Viscosity (cps) | 27,150 | 21,500 | 14,150 | 6,450 | 4,450 | 7,125 | 17,650 | 21,450 |
| % NCO | 1.6 | 1.6 | 1.7 | 1.8 | 1.9 | 1.8 | 1.67 | 1.98 |
| Exotherm (DT) (° C.) | 37 | 36.5 | 36.5 | 8.5 | 8.5 | 8.9 | 30 | 11 |
| Formulation | Yes | Yes | Yes | Yes | No | Yes | Yes | Yes |
| Compatibility | | | | | | | | |

Isocyanate Component is MDI and is commercially available under the trade name of Lupranate M from BASF.

Isocyanate Reactive Component 1 is polyether polyol and is commercially available under the trade name of Pluracol P710 from BASF.

Isocyanate Reactive Component 2 is Polyester polyol and is commercially available under the trade name of Diexter G DA66-30 from Coim.

Isocyanate Component 3 is polyester polyol and is commercially available under the trade name Millester 16-30 from SPI.

Isocyanate Component 4 is polyether polyol and is commercially available under the trade name Pluracol P220 from BASF.

Isocyanate component 5 is polyether polyol and is commercially available under the trade name Pluracol P2010 from BASF

Catalyst is amine based and is commercially available under the trade name of Luprogen N106 from BASF.

Viscosity is determined using Brookfield Thermosel, DV2T viscometer.

% NCO is determined using Metler Toledo T50 titrator.

Exotherm is determined using thermocouple.

Formulation Compatibility is determined using visual evaluation on lab roll coater and in storage container.

“Yes” indicates that there is homogeneity, as visually observed.

“No” indicates that there is not homogeneity, as visually observed. For example, particles may be observed in the melted adhesive, e.g. at 120-150° C.

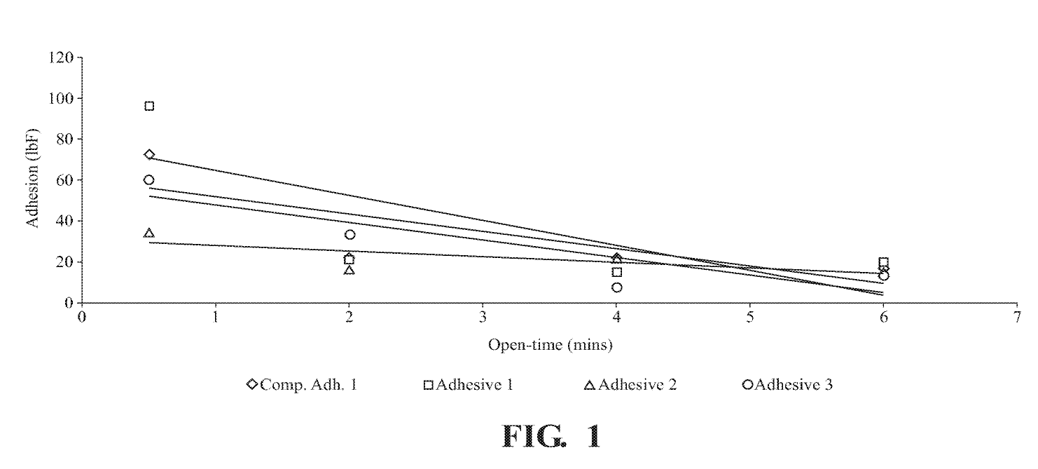

The Adhesives 1-3 and Comp. Adhesive 1 are then evaluated to determine multiple physical properties as set forth below and in FIGS. 1-9.

In a first evaluation, the Adhesives 1-3 and the Comparative Adhesive 1 are evaluated to determine adhesion (lbF) between white pine and Luan, at room temperature. Here, open time is determined as the time elapsed starting when the white pine, upon which adhesive is applied is disposed on the Luan and pressed. More specifically, adhesive (in an amount of 10 grams/ft²) is applied to the wood using a lab roll coater. Samples are pressed for 10 seconds with 90 psi of pressure using a pneumatic press. Samples are pulled after 5 minutes of close time. The results are set forth immediately below and in FIG. 1.

| Open | Comp. Adh 1 | Adhesive 1 | Adhesive 2 | Adhesive 3 |
|---|---|---|---|---|
| Time | Adhesion | Adhesion | Adhesion | Adhesion |
| (mins) | (lbF) | (lbF) | (lbF) | (lbF) |
| 0.5 | 72.95 | 96.15 | 34.7 | 60.1 |
| 2 | 21.5 | 21.25 | 16.95 | 33.5 |
| 4 | 22.35 | 16 | 21.8 | 7.9 |
| 6 | 17.6 | 19.8 | 15.45 | 14.4 |

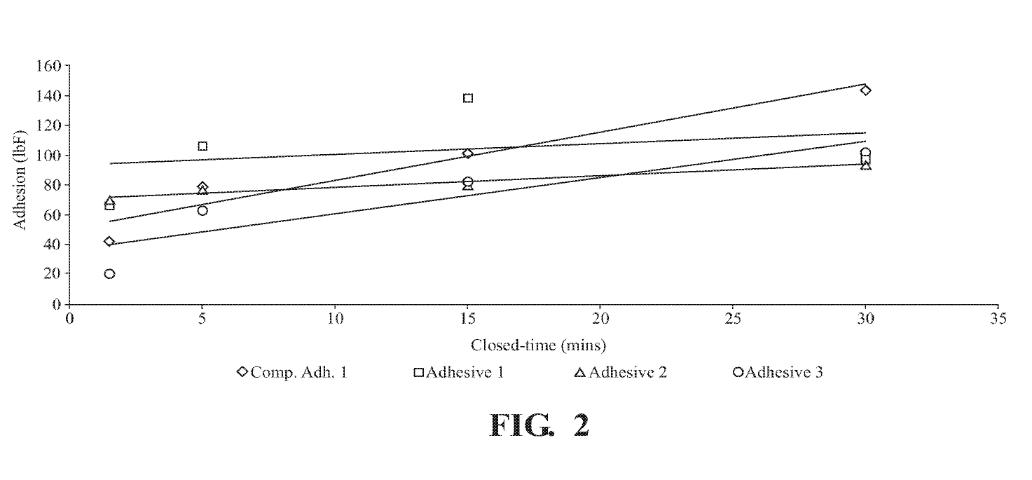

In a second evaluation, the Adhesives 1-3 and the Comparative Adhesive 1 are evaluated to determine adhesion (lbF) between white pine and Luan, as a function of close time at 100° F. Close time is defined as a time interval after the samples were pulled (tested) after pressing. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 2.

| Close | Comp. Adh 1 | Adhesive 1 | Adhesive 2 | Adhesive 3 |
|---|---|---|---|---|
| Time | Adhesion | Adhesion | Adhesion | Adhesion |
| (mins) | (lbF) | (lbF) | (lbF) | (lbF) |
| 1.5 | 43 | 67.7 | 70.3 | 21.8 |
| 5 | 78.95 | 106.7 | 76.15 | 64.6 |
| 15 | 102.6 | 139.25 | 81.2 | 83.55 |
| 30 | 144.9 | 97.8 | 94.6 | 102.75 |

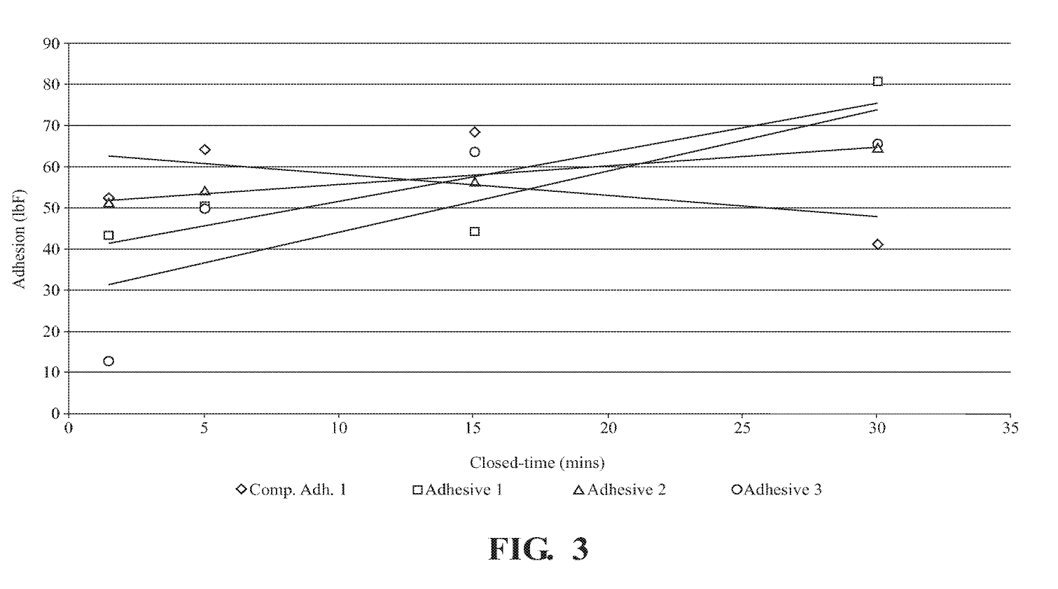

In a third evaluation, the Adhesives 1-3 and the Comparative Adhesive 1 are evaluated to determine adhesion (lbF) of MDF rail (medium density fiberboard) to Laurel (molded wood fiber facing) as function of close time at 100° F. More specifically, adhesive (in an amount of 10 grams/ft²) is applied to the MDF rail using a lab roll coater. Samples are pressed for 10 seconds with 90 psi of pressure using a pneumatic press. The results are set forth immediately below and in FIG. 3.

| Close | Comp. Adh 1 | Adhesive 1 | Adhesive 2 | Adhesive 3 |
|---|---|---|---|---|
| Time | Adhesion | Adhesion | Adhesion | Adhesion |
| (mins) | (lbF) | (lbF) | (lbF) | (lbF) |
| 1.5 | 52.4 | 43.55 | 51.55 | 12.95 |
| 5 | 64.2 | 50.8 | 54.6 | 50.5 |
| 15 | 68.8 | 44.65 | 56.85 | 64.1 |
| 30 | 41.1 | 80.8 | 65.15 | 65.95 |

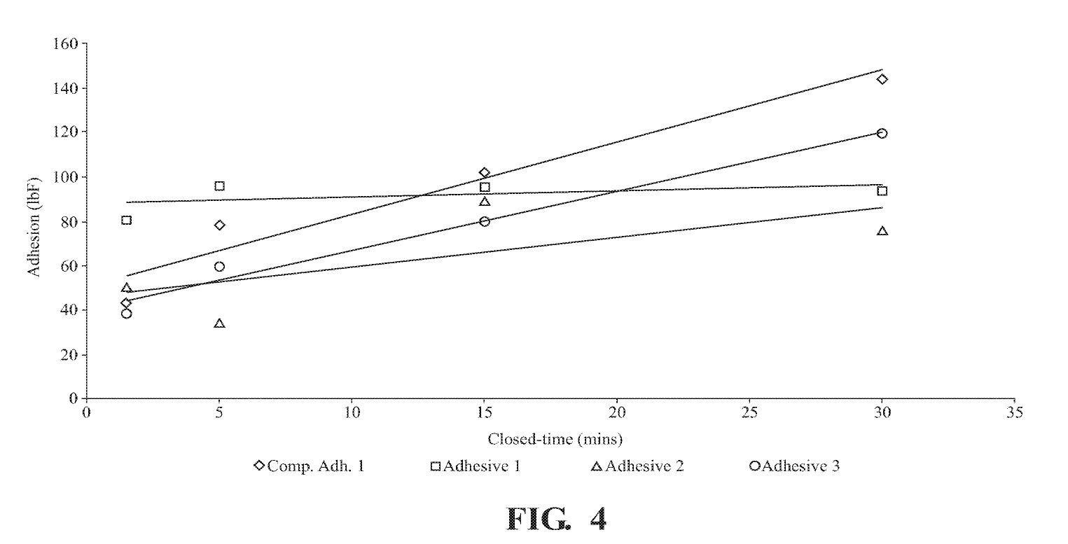

In a fourth evaluation, the Adhesives 1-3 and the Comparative Adhesive 1 are evaluated to determine adhesion (lbF) between white pine and Luan, at room temperature. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 4.

| Close | Comp. Adh 1 | Adhesive 1 | Adhesive 2 | Adhesive 3 |
|---|---|---|---|---|
| Time | Adhesion | Adhesion | Adhesion | Adhesion |
| (mins) | (lbF) | (lbF) | (lbF) | (lbF) |
| 1.5 | 43 | 80.7 | 51.4 | 39.35 |
| 5 | 78.95 | 96.15 | 34.7 | 60.1 |
| 15 | 102.6 | 95.15 | 90.05 | 79.95 |
| 30 | 144.9 | 94.5 | 76.95 | 119.85 |

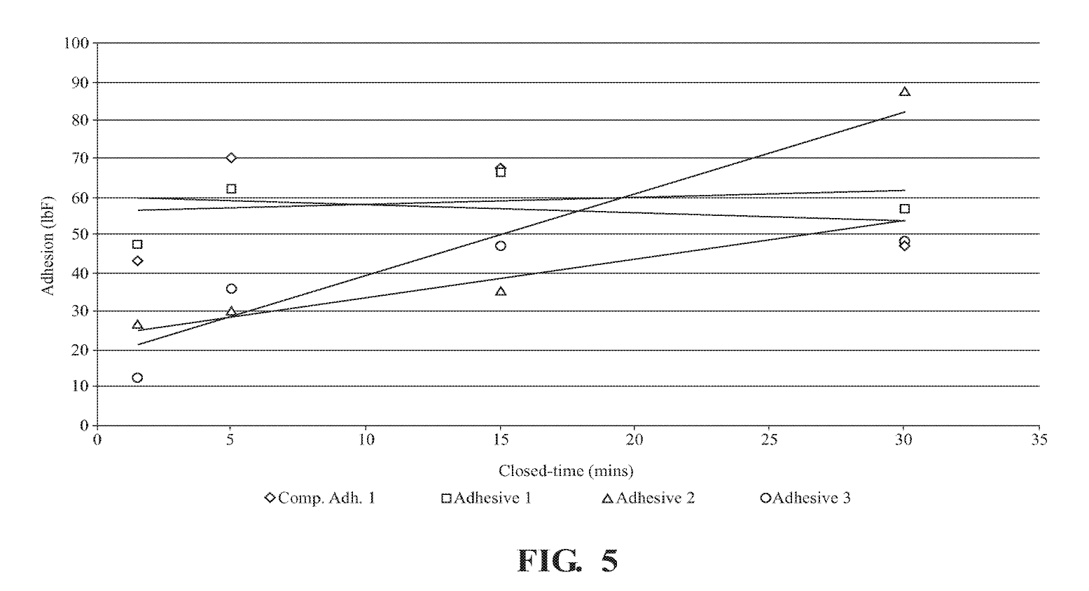

In a fifth evaluation, the Adhesives 1-3 and the Comparative Adhesive 1 are evaluated to determine adhesion (lbF) of MDF rail to Sacopan (molded wood fiber facing) at 100° F. More specifically, adhesive (in an amount of 10 grams/ft²) is applied to the MDF rail using a lab roll coater. Samples are pressed for 10 seconds with 90 psi of pressure using a pneumatic press. The results are set forth immediately below and in FIG. 5.

| Close | Comp. Adh 1 | Adhesive 1 | Adhesive 2 | Adhesive 3 |
|---|---|---|---|---|
| Time | Adhesion | Adhesion | Adhesion | Adhesion |
| (mins) | (lbF) | (lbF) | (lbF) | (lbF) |
| 1.5 | 43.4 | 47.95 | 27.2 | 13.2 |
| 5 | 70.7 | 62.25 | 30.7 | 36.05 |
| 15 | 67.3 | 66.8 | 35.8 | 47.35 |
| 30 | 47.15 | 57.25 | 88.45 | 48.75 |

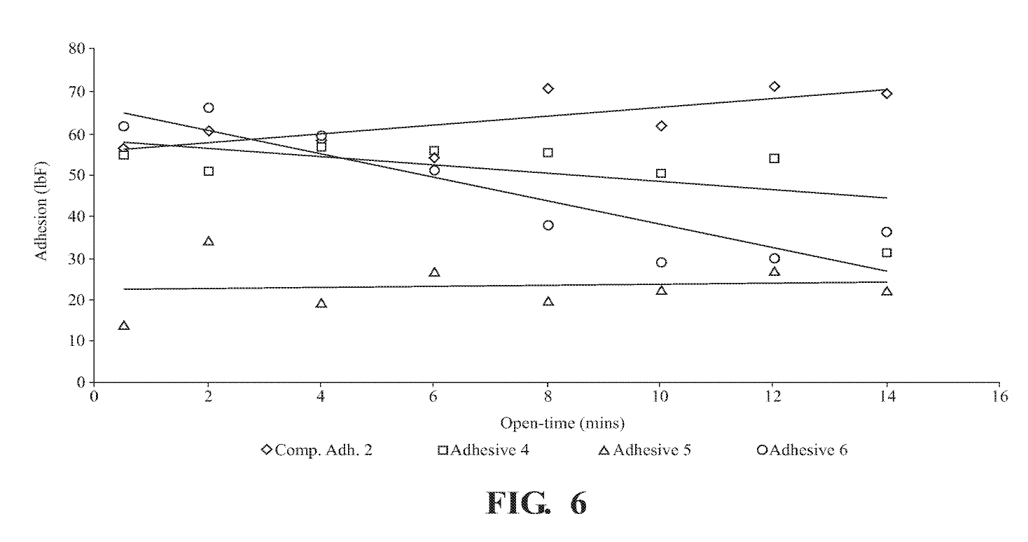

In a sixth evaluation, the Adhesives 4-6 and the Comparative Adhesive 2 are evaluated to determine adhesion (lbF) between white pine and Luan, as a function of open time at room temperature. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 6.

| Open | Comp. Adh 2 | Adhesive 4 | Adhesive 5 | Adhesive 6 |
|---|---|---|---|---|
| Time | Adhesion | Adhesion | Adhesion | Adhesion |
| (mins) | (lbF) | (lbF) | (lbF) | (lbF) |
| 0.5 | 56.15 | 54.6 | 14.35 | 61.6 |
| 2 | 60.65 | 50.9 | 34.6 | 65.9 |
| 4 | 58.25 | 56.7 | 19.5 | 58.75 |
| 6 | 54.25 | 55.9 | 26.95 | 51.2 |
| 8 | 70.8 | 55.5 | 20.2 | 37.9 |
| 10 | 61.95 | 50.4 | 22.9 | 29.05 |
| 12 | 71.2 | 54.2 | 27.35 | 29.9 |
| 14 | 69.4 | 31.4 | 22.55 | 36.35 |

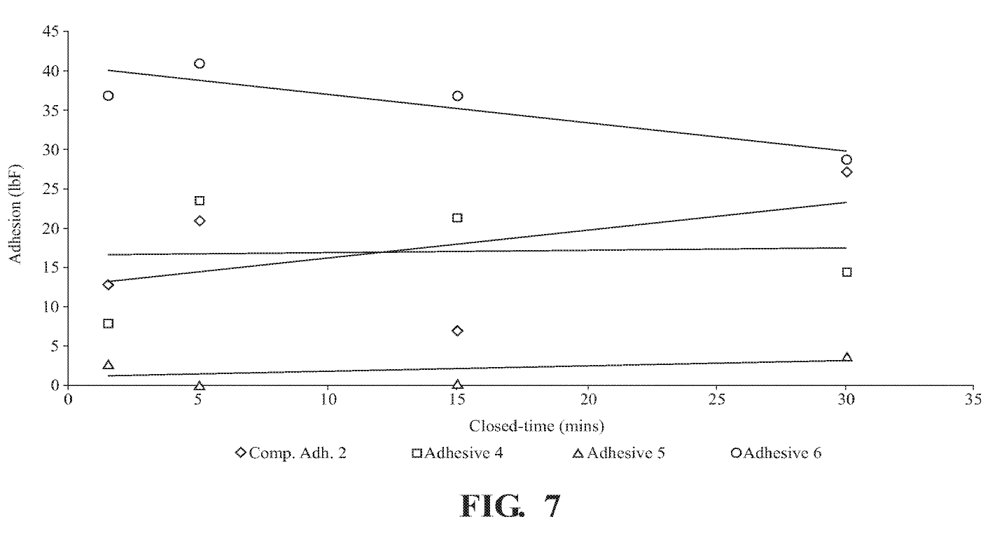

In a seventh evaluation, the Adhesives 4-6 and the Comparative Adhesive 2 are evaluated to determine adhesion (lbF) between white pine and Luan, as function of close time at 100° F. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 7.

| Close | Comp. Adh 2 | Adhesive 4 | Adhesive 5 | Adhesive 6 |
|---|---|---|---|---|
| Time | Adhesion | Adhesion | Adhesion | Adhesion |
| (mins) | (lbF) | (lbF) | (lbF) | (lbF) |
| 1.5 | 12.9 | 8.05 | 3.05 | 37 |
| 5 | 21.1 | 23.6 | 0.2 | 41.1 |
| 15 | 7.05 | 21.4 | 0.45 | 37 |
| 30 | 27.45 | 14.6 | 4 | 28.7 |

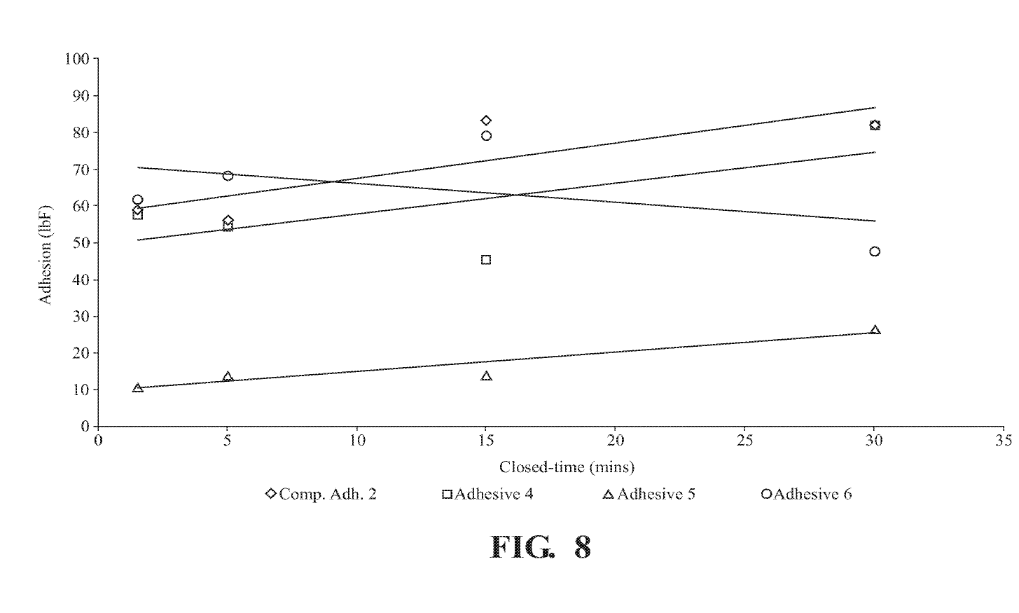

In an eighth evaluation, the Adhesives 4-6 and the Comparative Adhesive 2 are evaluated to determine adhesion (lbF) between white pine and Luan, as a function of close time at room temperature. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 8.

| Close | Comp. Adh 2 | Adhesive 4 | Adhesive 5 | Adhesive 6 |
|---|---|---|---|---|
| Time | Adhesion | Adhesion | Adhesion | Adhesion |
| (mins) | (lbF) | (lbF) | (lbF) | (lbF) |
| 1.5 | 59.1 | 58.1 | 11 | 61.6 |
| 5 | 56.15 | 54.6 | 14.35 | 68.5 |
| 15 | 83.9 | 45.5 | 14.4 | 79.8 |
| 30 | 82.2 | 82.2 | 26.9 | 48.2 |

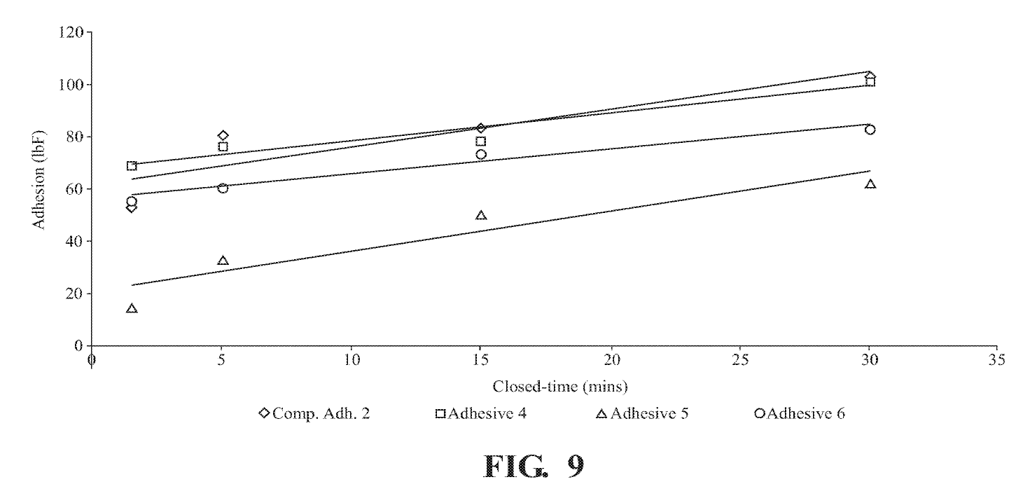

In a ninth evaluation, the Adhesives 4-6 and the Comparative Adhesive 2 are evaluated to determine adhesion (lbF) between white pine and Luan, as a function of close time at 50° F. More specifically, adhesive (in an amount of 10 grams/ft²) is applied to the wood using a lab roll coater. Samples are pressed for 10 seconds with 90 psi of pressure using a pneumatic press. The results are set forth immediately below and in FIG. 9.

| Close | Comp. Adh 2 | Adhesive 4 | Adhesive 5 | Adhesive 6 |
|---|---|---|---|---|
| Time | Adhesion | Adhesion | Adhesion | Adhesion |
| (mins) | (lbF) | (lbF) | (lbF) | (lbF) |
| 1.5 | 52.85 | 68.75 | 15.1 | 55 |
| 5 | 80.05 | 76.9 | 32.9 | 60.5 |
| 15 | 83 | 78.4 | 50.3 | 73.5 |
| 30 | 102.55 | 101.6 | 62.6 | 83.1 |

These results clearly demonstrated the styrene acrylic resins evaluated in the aforementioned formulations can be used as a cost effective additives to formulate reactive hot melt adhesives with good adhesive properties. Two of these styrene acrylic resins showed comparable performance (adhesion values) as comparative adhesives #1 and #2 (see, e.g. FIGS. 8, 9, 5, and Additives #4 and #1) and in some instances even high initial (instant) adhesion. For example, adhesive #6 shows significantly higher adhesion values between wood and Luan at 100° F. (see FIG. 7) than comparative adhesive #2. At same time, Adhesive #6 maintains a satisfactory open time. The improved performance at 100° F. can be attributed to the highest Tg (74° C.) of styrene acrylic resin. Materials with higher Tg start to thicken and solidify at higher temperatures, resulting in higher adhesion values at higher temperatures. Higher production environment temperatures and substrate temperatures are always challenging for hot melt adhesives to develop high enough initial adhesion and minimize delamination.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A reactive hot melt adhesive having a glass transition temperature of from 45° C. to 100° C. and comprising the reaction product of: an isocyanate component; and an isocyanate reactive component chosen from a polyester, a polyether, and combinations thereof; in the presence of a styrene acrylic resin that is free of hydroxyl functionality and that is the reaction product of 60 to 80 wt % of one or more monomers chosen from Ci to C20 alkyl acrylates and methacrylates and 20 to 40 wt % of one or more monomers chosen from vinylaromatics having a vinyl moiety having 2 or 3 carbon atoms.

2. The reactive hot melt adhesive of claim 1 wherein said styrene acrylic resin is the reaction product of a first acrylic monomer, a methyl methacrylate monomer, an n-butyl methacrylate monomer, and a styrene monomer.

3. The reactive hot melt adhesive of claim 2 wherein said first acrylic monomer is acrylic acid.

4. The reactive hot melt adhesive of claim 1 wherein said styrene acrylic resin is further defined as the reaction product of a combination of: from 0.5 to 1.5 parts by weight of said first acrylic monomer; from 10 to 55 parts by weight of said methyl methacrylate monomer; from 15 to 55 parts by weight of said n-butyl methacrylate monomer; and from 15 to 55 parts by weight of said styrene monomer; wherein each is independently chosen and based on 100 parts by weight of said combination.

5. The reactive hot melt adhesive of claim 1 wherein said reaction product of said isocyanate component and said isocyanate reactive component is further defined as a polyurethane prepolymer having unreacted isocyanate moieties.

6. The reactive hot melt adhesive of claim 5 wherein said polyurethane prepolymer is moisture curable at room temperature.

7. The reactive hot melt adhesive of claim 1 further comprising a moisture cured product of said isocyanate component.

8. The reactive hot melt adhesive of claim 1 wherein said styrene acrylic resin has a weight average molecule weight (M_{w}) of from 33,000 to 60,000 g/mol.

9. The reactive hot melt adhesive of claim 1 wherein said styrene acrylic resin has an acid number of from 5 to 10.

10. The reactive hot melt adhesive of claim 1 wherein said styrene acrylic resin has a glass transition temperature (T_{g}) of from 45 to 100° C.

11. The reactive hot melt adhesive of claim 1 wherein said styrene acrylic resin is present in an amount from 6 to 9 parts by weight based on 100 parts by weight of said reactive hot melt adhesive.

12. The reactive hot melt adhesive of claim 1 having an isocyanate (NCO) group content of from 1.6 to 1.7 wt %.

13. The reactive hot melt adhesive of claim 1 having a viscosity of from 14,000 to 28,000 centipoises (cP) at 250° C. measured using ASTM D1 084-08, a Brookfield Thermosel DV2T, and a #27 spindle.

14. The reactive hot melt adhesive of claim 1 that exhibits an initial adhesion of greater than 40 IbF as determined according to ASTM D905, D3807, D1062, or modified versions thereof and an open time of about 2 minutes as determined according to ASTM D4497-10 or a modification thereof.

15. The reactive hot melt adhesive of claim 1 wherein said styrene acrylic resin is present in an amount from 24 to 26 parts by weight per 100 parts by weight of said reactive hot melt adhesive.

16. The reactive hot melt adhesive of claim 1 a viscosity of from 4,400 to 7,200 centipoises (cP) at 250° C. measured using ASTM D1 084-08, a Brookfield Thermosel DV2T, and a #27 spindle.

17. The reactive hot melt adhesive of claim 1 wherein said reactive hot melt adhesive exhibits an initial adhesion of greater than 40 IbF as determined according to ASTM D905, D3807, D1062, or modified versions thereof and an open time of about 8 minutes as determined according to ASTM D4497-10 or a modification thereof.

18. An article comprising: a first surface; a second surface spaced from said first surface; and a reactive hot melt adhesive disposed between said first and second surfaces for coupling said first and second surfaces to one another, wherein said reactive holt melt adhesive has a glass transition temperature of from 45° C. to 100° C. and comprises the reaction product of; an isocyanate component, and an isocyanate reactive component chosen from a polyester, a polyether, and combinations thereof, in the presence of a styrene acrylic resin that is free of hydroxyl functionality and that is the reaction product of 60 to 80 wt % of one or more monomers chosen from Ci to C20 alkyl acrylates and methacrylates and 20 to 40 wt % of one or more monomers chosen from vinylaromatics having a vinyl moiety having 2 or 3 carbon atoms.

19. The article of claim 18 wherein said styrene acrylic resin is further defined as the reaction product of a combination of: from 0.5 to 1.5 parts by weight of said first acrylic monomer; from 10 to 55 parts by weight of said methyl methacrylate monomer; from 15 to 55 parts by weight of said n-butyl methacrylate monomer; and from 15 to 55 parts by weight of said styrene monomer; wherein each is independently chosen and based on 100 parts by weight of said combination.

20. The article of claim 18 wherein said reaction product of said isocyanate component and said isocyanate reactive component is further defined as a polyurethane prepolymer having unreacted isocyanate moieties.

21. The article of claim 18 wherein said polyurethane prepolymer is moisture curable at room temperature.

22. The article of claim 18 further comprising a moisture cured product of said isocyanate component.

23. The article of claim 18 wherein said first and second surfaces are each independently chosen from wood surfaces, plastic surfaces, metal surfaces, and combinations thereof.

24. A method of forming a reactive hot melt adhesive that has a glass transition temperature of from 45° C. to 100° C., said method comprising the steps of: providing an isocyanate component; providing an isocyanate reactive component chosen from a polyester, a polyether, and combinations thereof; providing a styrene acrylic resin that is free of hydroxyl functionality and that is the reaction product of 60 to 80 wt % of one or more monomers chosen from Ci to C20 alkyl acrylates and methacrylates and 20 to 40 wt % of one or more monomers chosen from vinylaromatics having a vinyl moiety having 2 or 3 carbon atoms; and combining the isocyanate component, the isocyanate reactive component, and the styrene acrylic resin such that the isocyanate component and the isocyanate reactive component react in the presence of the styrene acrylic resin to form the reactive hot melt adhesive.

25. The method of claim 24 wherein the step of providing the styrene acrylic resin is further defined as: continuously charging a mixture of (1) the one or more monomers chosen from Ci to C20 alkyl acrylates and methacrylates, (2) the one or more monomers chosen from vinylaromatics having a vinyl moiety having 2 or 3 carbon atoms, (3) a solvent, and (4) a polymerization initiator, into a reactor; maintaining the reactor at a temperature of from 150 to 190° C. to polymerize the monomers and form the styrene acrylic resin; and continuously removing the unreacted monomers and the solvent from the reactor to provide the styrene acrylic resin.

26. The method of claim 24 wherein the step of combining further comprises combining a flow modifier with the isocyanate component, the isocyanate reactive component, and/or the styrene acrylic resin.

27. The method of claim 24 further comprising the step of incorporating an additive into the reactive hot melt adhesive, wherein the additive is chosen from a moisture scavenger, a pigment, an optical absorber, and combinations thereof.
